(19) United States
(12) Patent Application Publication
(10) Pub. No.: US 2006/0117041 A1
(43) Pub. Date: Jun. 1, 2006

(54) Connection of an application to a resource manager selected from a plurality of resource managers

(76) Inventors: Malcolm David Ayres, Romsey (GB); David James Currie, Chandlers Ford (GB); Matthew Kelvin Vaughton, Hursley (GB); Graham Derek Wallis, West Wellow (GB)

Correspondence Address: IBM CORPORATION;INTELLECTUAL PROPERTY LAW, 11400 BURNET ROAD, AUSTIN, TX, 78758, US

(21) Appl. No.: 11/269,238

(22) Filed: Nov. 8, 2005

(30) Foreign Application Priority Data
Nov. 27, 2004 (GB) 0426125.1

(51) Int. Cl. G06F 7/00

(52) U.S. Cl. 707/100

(57) ABSTRACT

Disclosed is a method, apparatus and computer program for determining which resource manager of a plurality of resource managers an application may be connected to, given a connection request. A connection request is received which specifies a connection scope. The connection scope specifies the desired proximity of a suitable resource manager relative to the application's location. The application's location is determined and so are any resource managers that satisfy the connection request. The connection requester is then informed of at least one resource manager which satisfies the connection request.

### FIELD OF THE INVENTION

The present invention relates to the connection of an application to a resource manager selected from a plurality of resource managers.

### BACKGROUND OF THE INVENTION

A bus may contain many resource managers that are inter-connected such that every resource manager in the bus has at least one route to every other resource manager in the bus.

For ease, the following explanation will be given in terms of messaging engines and a messaging bus. It should however be appreciated that the invention is not limited to such.

A messaging engine typically permits an application to retrieve information from a destination (e.g. via get message request from queue x), to request processing of some work (e.g. a put message request to queue y, requesting the update of a database) and to connect to another messaging engine via the bus in order to access a destination (e.g. queue) owned by such a messaging engine. The bus provides location transparency, enabling an application connected to one engine in the bus to reach any part of the bus via that engine. See for example, http://www.sonicsoftware.com/news_events/docs/the451_{—}022304.pdf

An application may use a set of properties to control how they wish to be connected to a resource manager. These properties can contain such information as the name of the bus and the type of protocol to use. With no other constraints, in principle, an application may be connected to any messaging engine. However, while this will work functionally, connecting to an arbitrary engine may be undesirable in some situations. A performance critical application may need to connect to a particular engine—for example one that is “close” (proximate) to the application in terms of network delay.

During the Atlanta Olympics, a load balancing technique was used for managing access to the official Olympics website. When a client browser visited the website for the first time, a server hosting the site would send details of the client's IP address to each server via which access to the site could be gained. Each server would then ping the client and use this to record which server was the closest (in terms of network delay) to the client. Future attempts to access the Olympics site by the same client would then be redirected to the closest server. This is described in the article “Atlanta Olympics WOMplex” by Andy Stanford-Clark in AIXexpert Magazine, March 1997. The contents of this article was also presented at “Get Connected Technical Interchange '96 at IBM Hursley in October 1996. This process is however transparent to the client.

Other systems are known, whereby an application is connected to a server chosen by for example an IP sprayer (see http://64.233.167.104/search?q=cache:SURFepov5M0J:content.websitegear.com/article/load_balance_types.htm+%22IP+Sprayer%22&hl=en). The choice may be a random one or may be based on a factor such as load. Load Balancers are well-known—e.g. Network Dispatcher from IBM. Once again however, all of the above is transparent to the client.

### SUMMARY OF THE INVENTION

According to a first aspect, the invention provides a method for determining which resource manager of a plurality of resource managers an application may be connected to, given a connection request, the method comprising: receiving a connection request specifying a connection scope, the connection scope specifying the desired proximity of a suitable resource manager relative to the application's location; determining the application's location; determining which resource managers satisfy the received connection request; and informing the connection requester of at least one resource manager that satisfies the received connection request.

In one embodiment connection scope is specified in terms of a maximum acceptable network delay. For example a user could specify an acceptable maximum network delay of 5 seconds. Statistics could be maintained and used to determine which resources are capable of meeting such a requirement. Such statistics could be gathered by resources sending out data packets such that network throughput can be measured.

Alternatively an application might specify that the selected resource manager should be located, relative to the application itself, in one of: the same host, same node, same application server, same process, same cluster, same bus. Naturally the second option is an implicit specification of acceptable network delay. For example, a resource manager in the same process as the application will have no network delay as compared with a resource manager in the same cluster or host.

Other criteria could also be used as indicative of proximity—e.g. response time, number of network hops etc.

The invention preferably provides a way of controlling network traffic. The closer a resource manager is to a requesting application, the less traffic routed through the network to get to that resource manager.

Note, an application's location may be information that is transmitted with the connection request but this does not have to be the case. Instead, an application's location may be configured information which is accessed remotely. Other variations are possible.

The step of determining which resource managers satisfy the connection request, may involve receiving such information from another entity.

In one embodiment, the selection of a resource manager comprises determining that at least two connections points satisfy the connection request and selecting a resource manager from the at least two.

Determining which of the resource managers to select may be based on the resource manager having the greatest proximity to the application (e.g. in terms of network delay etc.).

In one embodiment, information is maintained about the location of resource managers and this is used to determine which resource managers satisfy the connection request. This information may be maintained by a separate entity to the original receiver of the connection request from the application. This receiver may forward the request onto the separate entity and that entity may either select a resource manager or provide a list of possible resource managers to the receiver for selection of one thereat. In order for the receiver to make an informed choice when provided with a selection of possible resource managers, the separate entity preferably provides resource manager location information to the receiver. Alternatively, the choice may be a random one or one based on user configured preferences (these may specify a priority order of choice).

According to a second aspect, the invention provides an apparatus for determining which resource manager of a plurality of resource managers an application may be connected to, given a connection request, the apparatus comprising: means for receiving a connection request specifying a connection scope, the connection scope specifying the desired proximity of a suitable resource manager relative to the application's location; means for determining the application's location; means for determining which resource managers satisfy the received connection request; and means for informing the connection requester of at least one resource manager that satisfies the received connection request.

According to a third aspect, the invention provides a method for an application to indicate what constitutes a suitable resource manager for the application to connect to when a plurality of resource managers are available, the method comprising: specifying a connection request having a connection scope, the connection scope specifying a location of a suitable resource manager relative to the application's location; and receiving information about at least one resource manager, the at least one resource manager satisfying the connection scope specified in the connection request.

According to a fourth aspect, the invention provides an apparatus for an application to indicate what constitutes a suitable resource manager for the application to connect to when a plurality of resource managers are available, the apparatus comprising: means for specifying a connection request having a connection scope, the connection scope specifying a location of a suitable resource manager relative to the application's location; and means for receiving information about at least one resource manager, the at least one resource manager satisfying the connection scope specified in the connection request.

Preferably the resource manager returned to the receiving step/receiving means is connected to.

In one embodiment, a plurality of resource managers satisfy the connection request. Information is received about one of the plurality of resource managers where the use of that resource manager is specified as mandatory.

It will be appreciated that the present invention may be implemented in computer software.

### BRIEF DESCRIPTION OF THE DRAWINGS

A preferred embodiment of the present invention will now be described, by way of example only, and with reference to the following drawings:

FIG. 1 is a component diagram of the environment in which the present invention can operate in accordance with a preferred embodiment;

FIG. 2 illustrates the detail of the workload manager (WLM) of FIG. 1 in accordance with a preferred embodiment of the present invention;

FIG. 3 illustrates the detail of the Topology Routing Manager (TRM) of FIG. 1, in accordance with a preferred embodiment of the present invention;

FIG. 4 illustrates the processing of the TRM in accordance with a preferred embodiment of the present invention; and

FIG. 5 shows the processing of the WLM in accordance with a preferred embodiment of the present invention.

### DETAILED DESCRIPTION

Below is provided a glossary of the terms used throughout the specification. Such a glossary is not intended to be limiting on the present application but is provided to aid explanation:

Glossary

Host: Computer
Node: “Virtual Host”—A host may be partitioned into one or more nodes, each with their own identity
Process: A context within an operating system having its own address space. Each process runs within a node and one or more processes typically collaborate to provide an application. For example, one process may display a GUI, whilst another may print a file.
Application: One or more processes working together to provide some functionality—e.g. email capability.
Application Server: The means by which an application may be executed.
Cluster: A group of application servers with some commonality. For example, an organising function (e.g. finance); or for the purpose of availability.
Bus: The means by which a set of resource managers may be connected together for the purpose of communicating with one another.
Messaging Engine (ME) The means by which each application server connects to a bus and achieves the processing of work/retrieval of information.

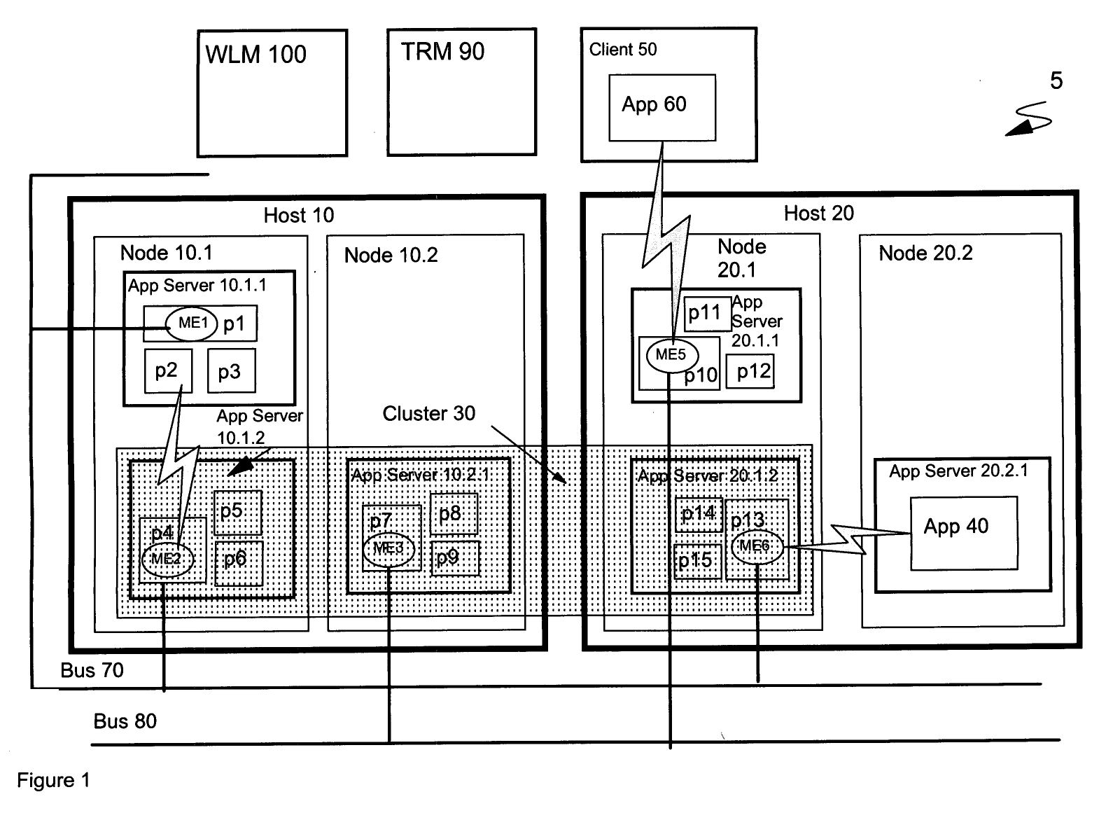

The present invention operates, in accordance with a preferred embodiment, in the environment shown in FIG. 1. A system 5 is shown having a plurality of hosts 10, 20. A host may accommodate one or more individually addressable nodes. Host 10, for example has two nodes 10.1, 10.2, whilst host 20 has two nodes 20.1, 20.2. Each node has at least one application server 10.1.1, 10.1.2, 10.2.1, 20.1.1, 20.1.2, 20.2.1. Each application server typically executes one or more processes which collaborate together to provide application functionality 40, 60. For example application server 10.1.1 executes processes p1, p2, p3 (which together denote an application—not referenced), whilst application server 10.1.2 executes processes p4, p5, p6. The processes making up applications 40 and 60 do exist but are not shown in the figure.

Certain application servers may be grouped together into clusters (one shown) 30. Certain processes run a messaging engine (ME) thereby enabling an application to access the destinations owned by the ME and to connect to a bus 70, 80 in order to access destinations owned by other MEs. For example p1 on application server 10.1.1 executes ME1 which owns destinations (not shown) and which provides a connection to bus 70.

Via busses 70 and 80, application servers are able to communicate with one another.

Client 50 also runs an application 60 which communicates with ME5 and is thus able to access bus 80.

The present invention, in accordance with a preferred embodiment, enables an application to specify a scoping constraint (connection scope), when connecting to a messaging engine. Such a scoping constraint can be used to enforce the use of a suitably “close” (proximate) messaging engine. In the preferred embodiment, “close” means any engine that may be connected to whilst avoiding or minimising networking delays.

TRM (Topology Routing Manager) component 90 collaborates to achieve a connection request with a WLM component 100. WLM keeps track of all the constituent parts of the environment described with reference to FIG. 1. When a messaging engine connects to a bus, it registers with WLM.

Note, there may be more than one WLM, each WLM being responsible for a subset of the environment—E.g. A group of hosts, nodes or application servers.

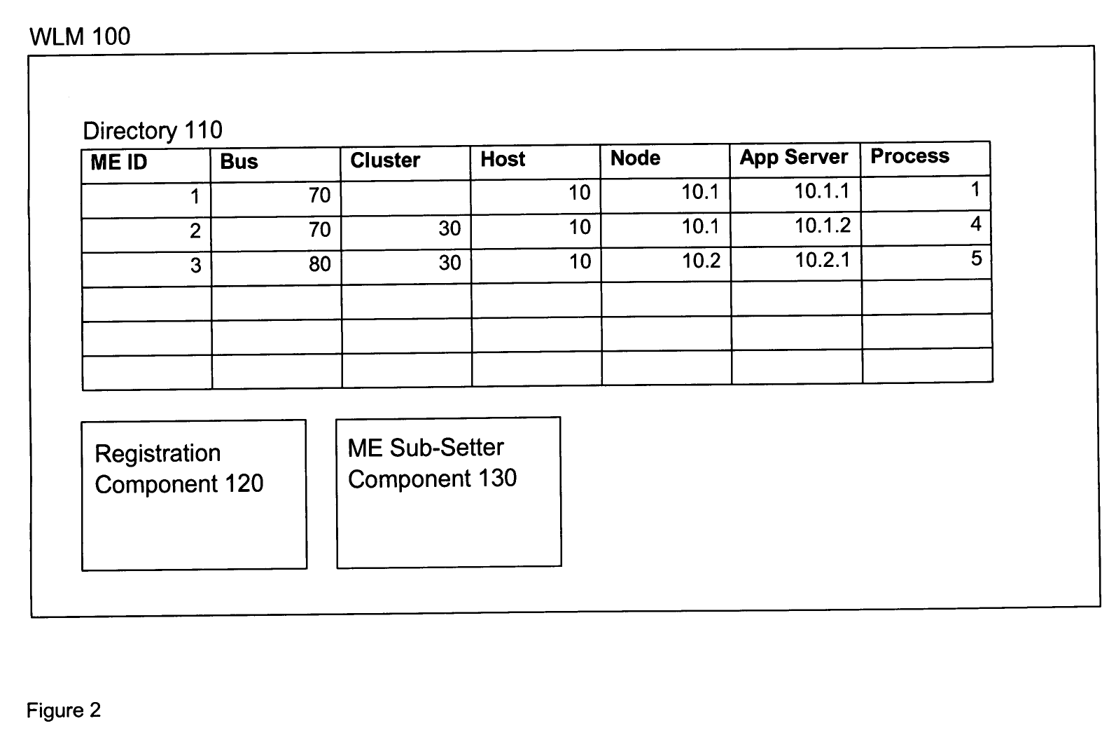

WLM is described in more detail with reference to FIG. 2. WLM includes a registration component 120. When a messaging engine connects to a bus, that engine registers with WLM using component 120. Such a registration involves providing, by way of example, WLM with the following information:

ME id; bus name; cluster id; host id; node id; application server id; and process id.

The ME of course knows its own id and the name of the bus that it connects to. The ME queries its owning process for its process id, the process queries its application server for an application server id, the ME queries whether it is part of a cluster and so on. In this way, suitable information is provided to the ME and the ME in turn provides this to WLM upon registration.

Such information is then stored by WLM in directory 110. Thus it can be seen that ME1 connects to bus 70, is not part of a cluster, is owned by process 1, within application server 10.1.1. That application server is on node 10.1 and the node sits on host 10.

WLM also includes an ME Sub-Setter component 130 but this will be described in more detail later.

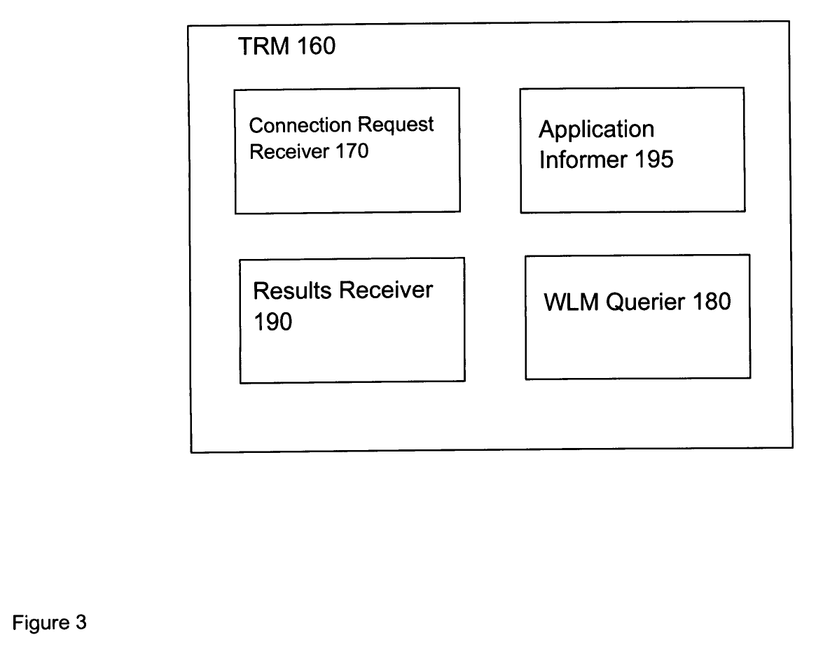

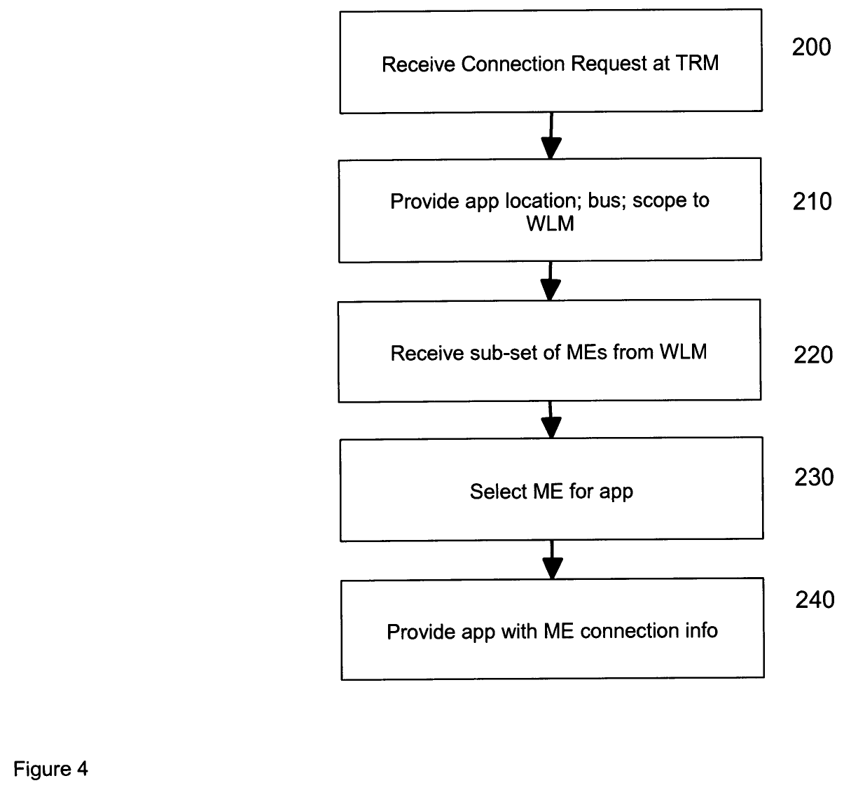

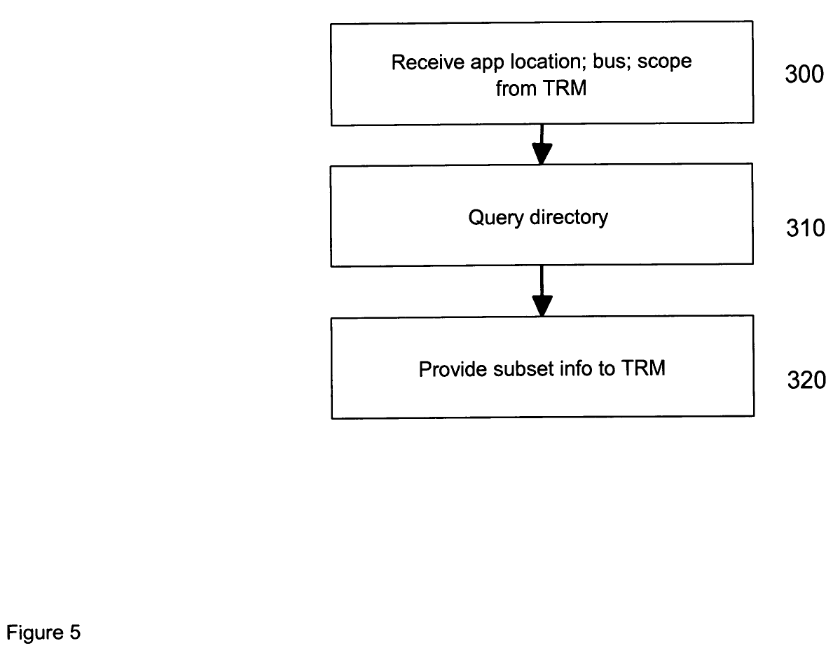

FIG. 3 illustrates the TRM component in more detail and FIGS. 4 and 5 show the processing of the preferred embodiment. FIG. 4 is from the point of view of TRM and FIG. 5 is from the perspective of WLM.

TRM receives connection requests from applications. An application may reside on a client 50 or on an application server. Such connections are received by Connection Request Receiver 170 (step 200) A connection request may include the location of the requesting application (alternatively this may be determined from administrator configured information or from the context in which the request is made etc.), a bus name (if there are multiple possibilities); and a connection scope. The connection scope may be tailored in accordance with the following options:

Connect to a messaging engine in the same:
Cluster;
Application Server;
Process;
Node; or
Host.

If “same bus” is specified, then any messaging engine on a particular bus may be chosen.

The connection request is received from the application, information is then extracted from such a request and is provided at step 210 to WLM (WLM Querier 180). Extracted information may include the requesting application's location, the name of the bus to connect to, and a connection scope.

WLM operates using such information to recommend an appropriate ME to the application (step 300). WLM queries its directory 110 using ME Sub-Setter Component 130 (step 310). A subset of MEs satisfying the specified connection scope is provided to TRM (step 320). The results are received by TRM's Receiver Component 190 (step 220). TRM then selects an appropriate ME (step 230) and informs the application of the ME to which it is to connect (Application Informer 195, step 240).

For example, the application comprising processes p1, p2 and p3 may specify that a connection scope of “same process” is required. From WLM's directory WLM would determine that ME1 satisfies the required criterion.

On the other hand, the same application may specify “same host”. From FIG. 1 it can be seen that this would provide a choice of ME1, ME2 or ME3.

WLM provides the subset of ME's to TRM and TRM would then select one of the MEs. In accordance with a preferred embodiment, TRM is likely to select the ME with the closest proximity to the application. This can be determined by querier WLM's directory information. Thus once again a suitable choice is ME1 since this sits within the same process as the application itself.

Note, in order for TRM to be able to determine which ME of a subset is the most suitable, WLM needs to provide TRM with information from its directory 110 about each ME in the Subset. In an alternative embodiment, WLM does not provide TRM with subset information but rather selects an appropriate ME from the subset itself.

Thus the present invention, in accordance with a preferred embodiment, permits an application to specify a connection scope. In this way an application's connection to a messaging engine may be controlled resulting in increased performance.

For example, certain nodes may have access to particular resources (e.g. databases). By specifying a connection scope of “same node”, it is ensured that the application will have access to appropriate resources.

Clusters can be used for certain functions, an example being that a cluster may be managing a particular messaging destination. By specifying a connection scope of “same cluster” an application can ensure that it will be granted a connection to an ME that is locally performing physical processing related to that destination.

A connection scope property of “same host” eliminates any network communications.

A connection scope of “same application server” permits interprocess communications but again eliminates network communication. Such an option may be chosen for reasons of communication efficiency.

Thus the present invention permits applications to scope their connections to a set of resource appropriately.

Note, whilst the present invention has been described in terms of messaging and messaging engines, the invention is not limited to such. Rather, the invention may apply to any set of connected resource managers and their resources.

Note, the connection scope information may be obtained in a number of different ways. For example, it may be hard-coded into the application itself; it may be obtained by reading separate profile information; a user may be prompted for the information etc.

1. A computer implemented method for determining which resource manager of a plurality of resource managers an application may be connected to, given a connection request, the method comprising:
receiving a connection request specifying a connection scope, the connection scope specifying a desired proximity of a suitable resource manager relative to the application's location;
determining the application's location;
determining which resource managers satisfy the received connection request; and
informing a connection requester of at least one resource manager that satisfies the received connection request.

2. The method of claim 1, wherein the connection scope is specified in terms of a maximum acceptable network delay.

3. The method of claim 1, wherein the connection scope specifies that a suitable resource manager should be located, relative to the application itself, in one of: the same host, same node, same application server, same process, same cluster, same bus.

4. The method of claim 1, further comprising:
determining that at least two resource managers satisfy the connection request; and
selecting a resource manager from the at least two resource managers; and
informing the connection requester of the selected resource manager.

5. The method of claim 4, wherein the step of selecting a resource manager from the at least two resource managers comprises:
selecting a resource manager which has the greatest proximity to the application.

6. The method of claim 1, further comprising:
maintaining information about the location of resource managers.

7. The method of claim 1, further comprising:
receiving information about the location of resource managers.

8. (canceled)

9. The method of claim 1, wherein a plurality of resource managers are identified as satisfying the connection requester's connection request, the method further comprising the step of:
informing the connection requester that one of the plurality of resource managers must be connected to.

10. (canceled)

11. Apparatus for determining which resource manager of a plurality of resource managers an application may be connected to, given a connection request, the apparatus comprising:
means for receiving a connection request specifying a connection scope, the connection scope specifying a desired proximity of a suitable resource manager relative to the application's location;
means for determining the application's location;
means for determining which resource managers satisfy the received connection request; and
means for informing a connection requester of at least one resource manager that satisfies the received connection request.

12. The apparatus of claim 11, wherein the connection scope is specified in terms of a maximum acceptable network delay.

13. The apparatus of claim 11, wherein the connection scope specifies that a suitable resource manager should be located, relative to the application itself, in one of: the same host, same node, same application server, same process, same cluster, same bus.

14. The apparatus of claim 11, further comprising:
means for determining that at least two resource managers satisfy the connection request;
means for selecting a resource manager from the at least two resource managers; and
means for informing the connection requester of the selected resource manager.

15. The apparatus of claim 14, wherein the means for selecting a resource manager from the at least two resource managers comprises:
means for selecting a resource manager which has the greatest proximity to the application.

16. The apparatus of claim 11, further comprising:
means for maintaining information about the location of resource managers.

17. The apparatus of claim 11, further comprising:
means for receiving information about the location of resource managers.

18. (canceled)

19. The apparatus of claim 11, wherein a plurality of resource managers are identified as satisfying the connection requester's connection request, the apparatus further comprising:
means for informing the connection requester that one of the plurality of resource managers must be connected to.

20. (canceled)

21. A computer implemented method for an application to indicate what constitutes a suitable resource manager for the application to connect to when a plurality of resource managers are available, the method comprising:
specifying a connection request having a connection scope, the connection scope specifying a location of a suitable resource manager relative to the application's location; and
receiving information about at least one resource manager, the at least one resource manager satisfying the connection scope specified in the connection request.

22. The method of claim 21 further comprising:
connecting to a resource manager returned to the receiving step.

23. The method of claim 21, wherein a plurality of resource managers satisfy the connection request, the step of receiving information about at least one resource manager comprising:
receiving information about one of the plurality of resource managers, use of the one being specified as mandatory.

24. (canceled)

25. (canceled)

26. (canceled)

27. A computer program comprising program code means adapted to perform a method for determining which resource manager of a plurality of resource managers an application may be connected to, given a connection request, when said program is run on a computer said method comprising the steps of:
receiving a connection request specifying a connection scope, the connection scope specifying a desired proximity of a suitable resource manager relative to the application's location;
determining the application's location;
determining which resource managers satisfy the received connection request; and
informing a connection requester of at least one resource manager that satisfies the received connection request.
